(19) United States
(12) Patent Application Publication
(10) Pub. No.: US 2014/0012569 A1
(43) Pub. Date: Jan. 9, 2014

(54) System and Method Using Data Reduction Approach and Nonlinear Algorithm to Construct Chinese Readability Model

(71) Applicant: National Taiwan Normal University, Taipei City (TW)

(72) Inventors: Yao-Ting SUNG, Taipei City (TW); Tao-Hsing CHANG, Taipei City (TW); Ju-Ling CHEN, Taipei City (TW); Yi-Shian LEE, Taipei City (TW)

(21) Appl. No.: 13/933,248

(22) Filed: Jul. 2, 2013

(30) Foreign Application Priority Data
Jul. 3, 2012 (TW) 101123917

(51) Int. Cl. G06F 17/28

(52) U.S. Cl. CPC G06F 17/28
USPC 704/9

(57) ABSTRACT

The invention constructs Chinese readability model with data reduction and smart/advanced artificial intelligence algorithm. The model contains 1) a word segmentation which segments words and tags the part of speech of the words. 2) a readability indicator unit which analyzes readability features based the segmented words segmentation and part of speech tagging; and 3) an evolution algorithm unit, which construct a Chinese text readability model using data reduction approach and smart/advanced artificial intelligence algorithm. The present invention assesses the readability of Chinese texts, based on a small amount of Chinese text, and identifies the adequate readers.

### BACKGROUND OF THE INVENTION

1. Field of the Invention

The present invention proposes a quantitative approach to Chinese readability. It constructs a Chinese readability model with the data reduction approach and smart/advanced artificial intelligence algorithm (nonlinear algorithm).

2. Description of Related Art

Due to the booming economy and burgeoning opportunities in China, the population of Chinese learners are rapidly growing. With easy access to the Internet, learning opportunities have expanded beyond classrooms. Nowadays, Chinese learners can improve their language skills on their own through the Internet, books, as well as articles. Therefore, how to select adequate Chinese learning materials for learners has become a primary concern for educators and researchers in the fields.

In theory, successful understanding of a subject matter hinges on the proper interaction between the reader and text. Text with high readability often contributes to improved reading comprehension and learning outcomes, as well as longer knowledge retention. A reading material appropriate for its intended readers also enhances reading motivation and boosts readers' reading achievement. From an educational perspective, it is relatively easier to control the text features than the reader factors. The text features are, in fact, more educational, which can significantly enhance reading comprehension.

Thanks to the development of the Internet, a considerable number of reading materials have become more available, and selecting the adequate materials has become crucial. In fact, many systematic methods have been developed for effectively selecting adequate reading materials. Without a systematic approach, it would be difficult to select texts with appropriate reading level. A quantitative approach facilitates the selection of adequate reading materials. In addition, a Chinese-specific readability model can assess the readability of a Chinese text.

In this proposal, readability is defined as the degree to which a text can be understood, and enhance reader's comprehension.

In the early 1920s, the alphabetic writing system has been analyzed by various readability formulas using word count and syntax. Even though the readability research on the alphabetic writing system matures with time, there are still problems to be solved, including low availability of features, overly primitive formulaic models, and overly shallow features. In contrast to the well-developed readability research on the alphabetic writing system, the Chinese system is relatively understudied. For example, some researchers focused on the discussion about the essential factors that may affect Chinese readability (e.g. character and sentence length etc.), and also established readability formula, but its validity was not studied. Other researchers attempted to establish readability formulas for Chinese by directly referring to the feature of readability used in alphabetic writing system. However, only educational textbook information database is used as a reference when commonly used vocabulary is established. In other words, no other external corpus is taken into consideration, and therefore such methodology is considered to be biased.

Since the alphabetic writing system is fundamentally different from the Chinese system, the present invention sees the need for a Chinese readability system that is developed with valid readability features and formulas. In fact, many previous studies on Chinese text readability adopt sentence length, stroke numbers, commonly used words (hard word ratio) and other features to establish Chinese readability formulas. Though the number of stroke is specific to Chinese, it is equivalent to the number of syllables in the alphabetic languages. Therefore, there is no distinction between the features commonly found in alphabetic writing system and those in Chinese readability formulas. In addition, most research adopt only minor and surface linguistic features to construct their Chinese readability formulas. Hence, these Chinese readability formulas cannot effectively evaluate the readability of the Chinese text.

Traditional readability formulas (e.g. Flesch-Kincaid) have been widely applied in education and other realms. Some applications include academic article categories in the library, electronic books, and the content of commercial websites.

There are three major issues with the current readability formulas: first, the features are too few to account for the complexity of the text; second, although some researchers attempted to adopt multiple features, they still failed to overcome many feature-related issues; third, the current Chinese text readability classification models are based on overly simplistic statistical methods, which yield low rates of correctness. Therefore, it is important to improve the accuracy of the current Chinese readability classification model. In general, constructing an effective text readability model usually requires large amount of input in order to stabilize the model. Even those alphabetic models face the problems such as instability, undistributed feature, and other related issues. More work needs to be done to solve these problems.

In order to solve these problems, the current invention takes into account the multi-level features of readability, and addresses the problem of colinearity between features. In particular, the present study proposes a data reduction method that integrates various readability indexes and a non-linear algorithm. Through the Chinese text readability features, we construct a highly accurate Chinese text readability model with features of strong analytical power. The present invention is the result of a series of research experimental efforts.

### SUMMARY OF THE INVENTION

In view of the existing technology, the traditional readability model is no longer adequate for analyzing the readability of Chinese text. The predicting ability of the traditional readability model is also not desirable due to the insufficient data input for analysis. Moreover, the features are interdependent, which may affect the readability model and give rise to problems such as colinearity. The present invention constructs a highly accurate and efficient Chinese text readability model by selecting multiple Chinese text readability features (e.g. vocabulary, semantics, syntax, paragraph structure, etc.). Moreover, with a reasonable number of texts, the inventors also construct the Chinese text readability model with the data reduction method and smart/advanced artificial intelligence algorithm.

To achieve these objectives, the present invention proposes a method for constructing Chinese readability model through data reduction and smart/advanced artificial intelligence algorithm. The procedure includes the following steps: (A) collect Chinese texts for readability test and compare with the texts in the corpus to generate word segmentations and part of speech tagging; (B) calculate the feature values for each text; (C) identify the reading comprehension factors through data reduction, which also solves the problem of colinearity; (D) construct the model to evaluate the readability of Chinese text.

In addition, in step (C), the data reduction method can be used to reduce colinearity between the features, while also keeping important reading comprehension factors.

In step (D), the smart/advanced artificial intelligence algorithm converts the value of the reading comprehension factors with mathematical functions (such as sin, cos) to evaluate the readability of the Chinese text.

In step (A), the corpora include CKIP Chinese Electronic Dictionary, Sinica Corpus, or Sinica Treebank. The aforementioned readability features include lexical, semantic, syntactic and cohesive features. These features compose the reading comprehension factors.

In step (C), with data reduction, these features are categorized into reading comprehension factors. Each factor can then be represented as the linear combination of all features. The present invention further proposes a system and method using data reduction approach and smart/advanced artificial intelligence algorithm. The Chinese readability model comprises a word segmentation unit, a readability indicator unit, and an evolution algorithm unit. The word segmentation unit first receives a Chinese text of a known reading level, and then compares the Chinese features (e.g. words, sentences, and phrases) with the text in the corpus to segment the words in the text, and tag the part of speech for the segmented words. Each Chinese text is assigned some readability features. The readability indicator unit receives the segmented words with part of speech tagging, and calculates the feature value. The evolution algorithm unit determines the readability comprehension factor through the data reduction method, and constructs a Chinese readability model using the smart/advanced artificial intelligence algorithm. This model serves as a criterion for judging whether the Chinese text is suitable for reading for a predetermined reading level.

The present invention constructs a Chinese readability model with data reduction and smart/advanced artificial intelligence algorithm. The model includes a word segmentation unit, a readability indicator unit, and a smart/advanced artificial intelligence unit. The word segmentation unit receives Chinese text for comparative analysis with the texts in the corpus, in order to generate word segmentations and tag their part of speech.

Each text has its readability features. The readability indicator unit calculates the feature values based on the results from the word segmentation unit. The smart/advanced artificial intelligence unit then identifies a reading comprehension factor and builds the readability model through the smart/advanced artificial intelligence algorithm. The model evaluates the readability of Chinese texts.

The above description and following examples are provided herein to illustrate the scope of the invention. Other advantages and effects of the invention will become more apparent from the disclosure of the present invention.

### BRIEF DESCRIPTION OF THE DRAWINGS

### Diagram

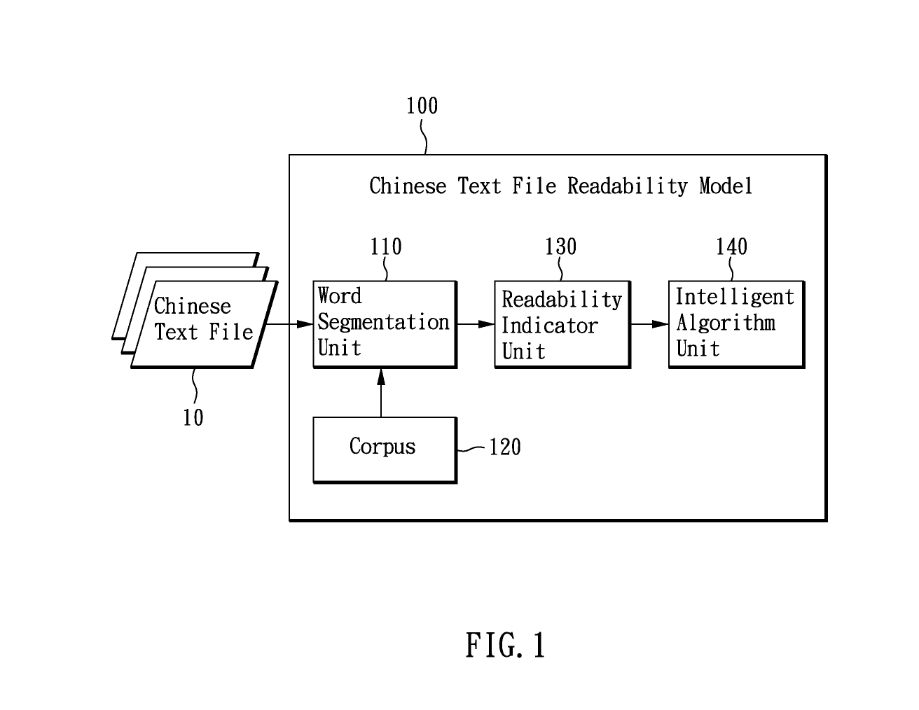

FIG. 1 shows the establishment of Chinese readability model using data reduction method and smart/advanced artificial intelligence algorithm based on the ideal configuration of the system;

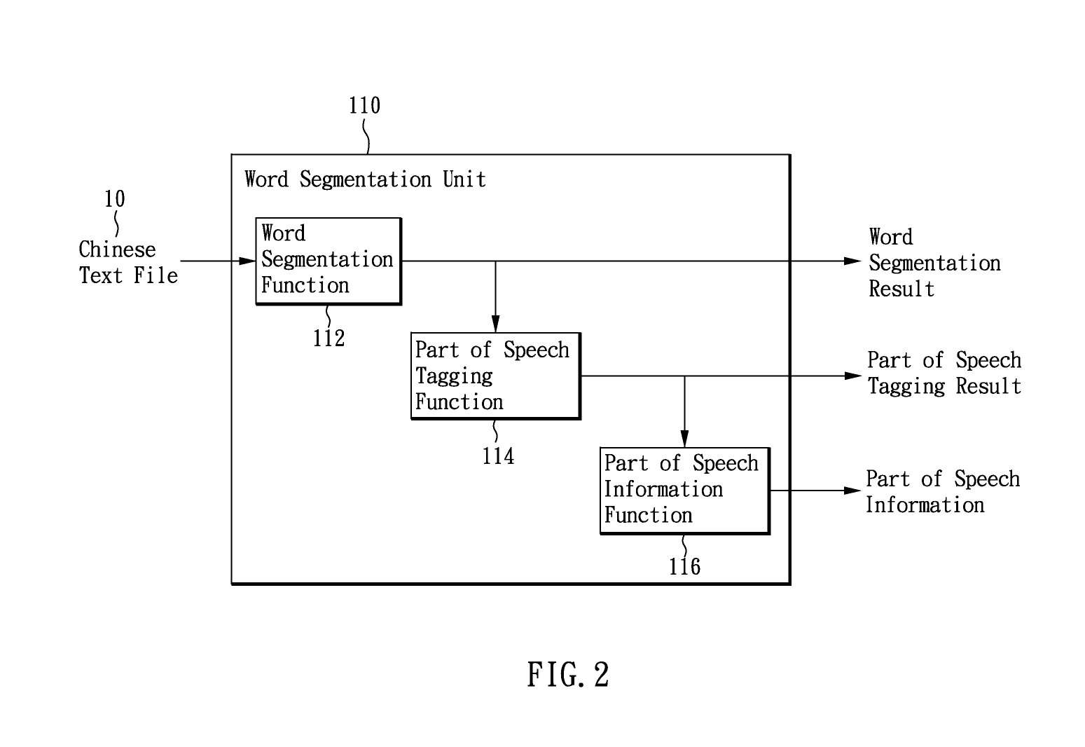

FIG. 2 illustrates a word segmentation unit based on a preferred embodiment of the present invention;

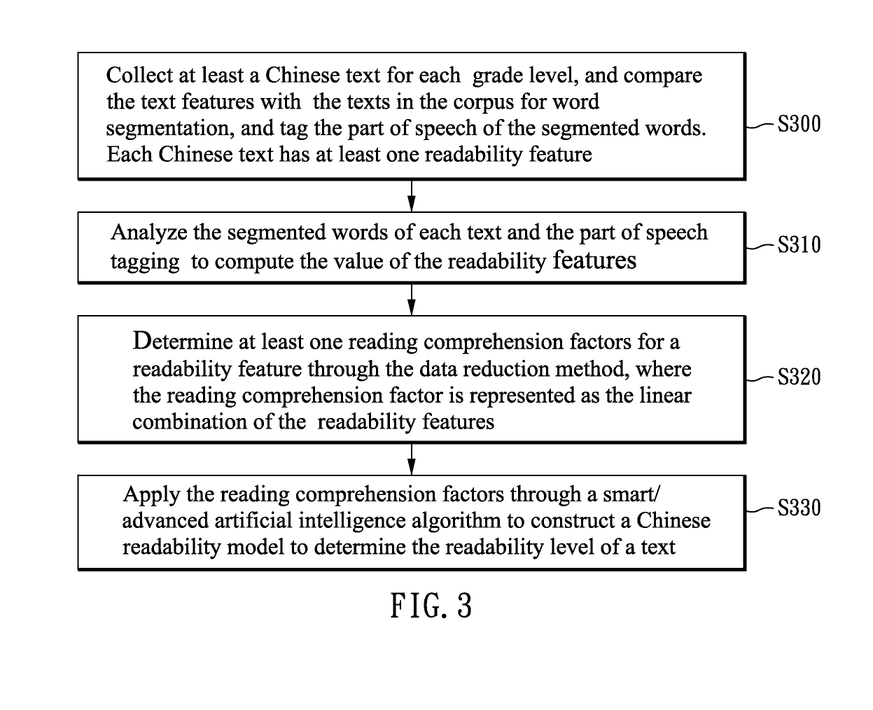

FIG. 3 is a flow chart demonstrating the establishment of the Chinese readability text using data reduction method and smart/advanced artificial intelligence algorithm based on a preferred embodiment of the present invention.

### DETAILED DESCRIPTION OF THE PREFERRED EMBODIMENT

FIG. 1 shows a Chinese text readability model 100 using data reduction method and smart/advanced artificial intelligence algorithm. As shown in FIG. 1, the Chinese text readability model 100 comprises a word segmentation unit 100, a readability indicator unit 130, and an evolution algorithm unit 140. The word segmentation unit 110 receives multiple Chinese texts 10 for a certain grade level, and compares the features with (e.g. word, sentence, and phrases) the text in the corpus to segment words and tag part of speech. Each text 10 has its own readability features (figure not shown).

In the present embodiment, the Chinese text 10 can be, but not restricted to, texts, files from a book, online materials, etc. Other forms such as computers, servers, or cloud servers are also possible. Word segmentation unit 110 segments the Chinese texts and label them with part of speech for later analysis. In other words, word segmentation is extremely crucial for text analysis. Incorrect word segmentation can lead to errors in tagging part of speech, and ultimately in semantic misinterpretation.

Furthermore, corpus 120 can be selected from the CKIP Chinese Electronic Dictionary, Sinica Corpus, or Sinica Treebank.

FIG. 2 shows the word segmentation unit. The segmentation unit 110 includes a segmentation function 112, a part of speech tagging function 114, and a part of speech information function 116. The word segmentation function 112 receives the Chinese text 10 and segments the words by comparing them with the corpus. The results are then tagged with part of speech and relevant information by the corresponding functions.

The readability indicator unit 130 receives the results of word segmentation and the part of speech tagging of the Chinese text 10. The unit then calculates the value of the readability features. The readability features can be classified as lexical, semantic, syntactic, and cohesive categories.

In the present embodiment, the readability feature can be classified into word features, semantic features, syntactic features, and coherence features: (1) word features include lexical diversity, word frequency, word length, and other lexical features; (2) semantic features include semantics, latent semantics, and other semantic features; (3) syntax features include average sentences length, the ratio of simple sentences, and other syntactic features; (4) coherence features include referential words, conjunctions, and other coherence features. The aforementioned features constitute a set of important components for understanding articles to provide more exact and comprehensive readability features. The present embodiment is merely one preferred embodiment of the present invention, and is not restricted to these features.

With the data reduction method, the evolution algorithm unit 140 is able to determine the significant features for reading comprehension. These reading comprehension factors are groups of features categorized by data reduction. This data reduction method is capable of solving the colinearity issue shared by most traditional readability models. In other words, the present invention provides a solution to the problem of feature colinearity. Using the present data reduction method can reduce colinearity among the features and ultimately yield the following benefits: (1) representativeness—retaining the accountability of the readability features; (2) independence—reducing the colinearity between features; (3) preciseness—replace the complex readability features with reading comprehension factors for the purpose of further analysis.

After the evolution algorithm unit 140 obtains the reading comprehension features, the unit then gradually establishes a Chinese readability model 100 with a smart/advanced artificial intelligence algorithm. After the process is complete, the Chinese text readability model 100 receives a Chinese text for analysis. This Chinese text readability model 100 will be used as a benchmark for determining whether it is appropriate for a particular grade level, and what grade level is suitable for the text. In other words, the results indicate the grade level that the text belongs. The present invention is therefore, capable of giving an accurate prediction of the text's readability.

In addition, in the current embodiment, the smart/advanced artificial intelligence algorithm serves to integrate the features relevant to reading comprehension. The Smart/Advanced Artificial Intelligent Algorithm selects the parameters based on trial-and-error. The smart/advanced artificial intelligence algorithm is neither restricted by the data size, nor by the traditional linear formulas (e.g. normal distribution). Therefore, the model can yield an accurate prediction even with small amount of input.

FIG. 3 demonstrates the constructing process of the Chinese readability model 100 using data reduction method and smart/advanced artificial intelligence algorithm. Below are examples of Chinese texts 10 used by Grade 3 and Grade 4 students. The texts are first entered into the model and then are compared with a corpus 120. After the comparison process is complete, the word segmentation unit segments each text 10 and tags their part of speech for further analysis (Step S300).

The readability feature can be categorized as lexical and syntactic features. The lexical features include: character count (total character count), word count (total word count), and low-stroke characters (total character count for writing stroke that is between 1˜10). The syntactic features include average sentences length and the ratio of simple sentences.

The Chinese readability model 100 then analyzes the segmented phrases and their part of speech in the readability indicator unit. The model then calculates the value for each feature, feature including feature character count, word count, low-stroke character count, average sentence length, and the ratio of simple sentences. For example, a Chinese text 10 for Grade 3 has 100 characters, 47 words, 53 low-stroke characters, 3 words per sentence, and the ratio of simple sentence is 35%. In the present case, none of the readability features has the identical value. Each feature value is individually normalized with the same measurement. (step S310).

Subsequently, the Chinese text readability model 100 will determine the critical reading comprehension factor through the data reduction method, which integrates the features into several important reading comprehension factors, and each reading comprehension factor can be represented as a linear combination of the readability features in the same feature category. (step S320)

Based on such an approach, two critical reading comprehension factors can be obtained—the lexical and syntactic comprehension factors (figure not shown). The lexical comprehension factor is a linear combination of characters, words, low-stroke characters. The syntactic comprehension factor is a linear combination of average sentence length and the proportion of simple sentences. As shown below,

Vocabulary Comprehension Factor=a1×(Characters)+a2×(Words)+a3×(Low-Stroke Characters);

Syntax Comprehension Factor=b1×(Average Sentence Length)+b2×(Simple Sentence Ratio);

Where, a1, a2, a3 are the coefficients of characters, words, and low-stroke characters in the lexical feature category. B1, b2 are the coefficients of the average sentence length, the proportion of simple sentences in the syntactic feature category.

In Summary, the evolution algorithm unit 140 categorizes readability features (including characters, words, low-stroke characters, average sentence length, the proportion of simple sentences), into lexical feature (including characters, words, low-stroke characters), and syntactic feature category (including average sentence length and the ratio of simple sentences). The evolution algorithm unit 140 also linearly combines the readability features of the same feature category to construct the lexical and syntactic comprehension factor. Through the data reduction method, the current invention integrates the originally complex readability features into two critical reading comprehension factors, and overcomes the issue of coliearity.

Last, like in the evolution algorithm unit 140, the two important reading comprehension factors are used to construct the Chinese text readability model 100 through the smart/advanced artificial intelligence algorithm. This serves as a criterion for selecting Chinese texts adequate for Grade 3 and 4 students. The Chinese text readability model 100 also serves the purpose of establishing a highly accurate Chinese text readability model 100. (step S330)

In the present embodiment, the Chinese text readability model 100 can be constructed by the following formula:

Grade class=sin(vocabulary comprehension factor)+log(syntax comprehension factor).

This formula converts the value of the reading comprehension factors with nonlinear functions (sin, log, logistic), and linearly combined the converted values (e.g. sin for lexical comprehension factors, log for syntactic comprehension factor). The present embodiment is only a preferred embodiment of the current invention, and does not preclude any addition or adjustment of other readability features, readability comprehension factors, and nonlinear functions.

Therefore, the Chinese text readability model 100 can determine whether a Chinese text is an adequate reading material for Grade 3 and Grade 4 students.

In summary, the present invention constructs a Chinese text readability model 100 with data reduction method and smart/advanced artificial intelligence algorithm to effectively predict the readability of a Chinese text. In addition, the present invention resolves the problem of traditional readability models in analyzing Chinese text, such as poor predictive power due to insufficient amount of Chinese text. It also overcomes the issue of colinearity between features to achieve higher accuracy. The Chinese text readability model 100 of the present invention is more accurate than the traditional readability models, and can therefore identify the adequate texts for the readers.

Although the present invention has been explained in relation to its preferred embodiment, it is to be understood that many other possible modifications and variations can be made without departing from the spirit and scope of the invention as hereinafter claimed.

What the claim is:

1. A method for constructing a Chinese readability model by using data reduction approach and smart/advanced artificial intelligence algorithm, which includes the steps:
(A) collect at least a Chinese text for each grade level, and compare the text features with the texts in the corpus for word segmentation, and tag the part of speech of the segmented words. Each Chinese text has at least one readability feature;
(B) analyze the segmented words of each text and the part of speech tagging to compute the value of the readability features;
(C) determine at least one reading comprehension factors for a readability feature through the data reduction method, where the reading comprehension factor is represented as the linear combination of the readability features; and
(D) apply the reading comprehension factors through a smart/advanced artificial intelligence algorithm to construct a Chinese readability model to determine the readability level of a text.

2. As in 1 (C), the data reduction method overcomes the issue of colinearity between the readability features.

3. As in 2 (D), the smart/advanced artificial intelligence algorithm nonlinearly forms at least one reading comprehension factor.

4. As in 1 step (A) the corpus is the CKIP Chinese Electronic Dictionary, Sinica Corpus, or Sinica Treebank, where the corpus serves as a criterion for comparing Chinese features.

5. As in 1 (A), at least one readability feature comprises word feature, semantic feature, syntactic feature, and article coherence feature, where the readability feature serves as a criterion for determining the reading comprehension factors.

6. As in 5 (C), at least one reading comprehension factor is represented as the features in the same feature category, which is classified through data reduction method, Each reading comprehension factor is represented as the linear combination of the readability feature in the same feature category.

7. A system for constructing Chinese readability model by using data reduction approach and smart/advanced artificial intelligence algorithm, which includes:
a word segmentation unit for receiving at least one Chinese text suitable for a predetermined reading level, and comparing with Chinese features of a corpus to segment the words and to tag part of speech for the segmented words, where each Chinese text is assigned a readability feature;
a readability feature unit for receiving the results of word segmentation and part of speech tagging to calculate the feature values; and
an evolution algorithm unit for receiving the readability features and determining at least a reading comprehension factor through a data reduction method, using the smart/advanced artificial intelligence algorithm. It constructs a Chinese readability model based on at least one reading comprehension factor. The model evaluates whether the Chinese text is suitable for a predetermined reading level, where at least one reading comprehension factor is represented as a linear combination as at least one readability feature.

8. As in claim 7, where the data reduction method overcomes colinearity between the readability features.

9. As in claim 8, where the smart/advanced artificial intelligence algorithm nonlinearly forms at least one reading comprehension factor.

10. As in claim 7, the linguistic corpus serves as the benchmark for comparing text features, where the corpus includes CKIP Chinese Electronic Dictionary, Sinica Corpus, or Sinica Treebank.

11. As in claim 7, at least one readability feature belongs to word feature, semantic feature, syntactic feature, or cohensive feature, where the readability features determine the reading comprehension factors.

12. The system according to claim 11, wherein the reading comprehension is represented expressed as the features in the same feature category, which is created by data reduction. Each reading comprehension factor is represented as the linear combination of the readability features in the same feature category.
